(19) United States
(12) Patent Application Publication
(10) Pub. No.: US 2005/0021968 A1
(43) Pub. Date: Jan. 27, 2005

(54) Method for performing a trusted firmware/bios update

(76) Inventors: Vincent J. Zimmer, Federal Way, WA (US); Michael A. Rothman, Gig Harbor, WA (US)

Correspondence Address: R. Alan Burnett;BLAKELY, SOKOLOFF, TAYLOR & ZAFMAN LLP, Seventh Floor, 12400 Wilshire Boulevard, Los Angeles, CA, 90025-1026, US

(21) Appl. No.: 10/607,367

(22) Filed: Jun. 25, 2003

(51) Int. Cl. H04L 9/00

(52) U.S. Cl. 713/176

(57) ABSTRACT

A method for providing a secure firmware update. A first authentication credential is securely stored on a platform in an encrypted form using a key generated by a secure token, such as a trusted platform module (TPM). Typically, the authentication credential will identify a manufacture and the operation will be performed during manufacture of the platform. A configuration of the platform is “imprinted” such that an identical configuration is required to access the key used to decrypt the first authentication credential by sealing the key against the platform configuration. During a subsequent firmware update process, a firmware update image containing a second authentication credential is received at the platform. If the platform configuration is the same as when the key was sealed, the key can be unsealed and used for decrypting the first authentication credential. A public key in the first authentication credential can then be used to authenticate the firmware update image via the second authentication credential.

### FIELD OF THE INVENTION

The field of invention relates generally to computer systems and, more specifically but not exclusively relates to a technique employing trusted platform and CPU technology in order to effect a trusted firmware/BIOS update in a pre-boot operational environment.

### BACKGROUND INFORMATION

Many modern computing systems (i.e., platforms) enable system firmware (e.g., BIOS) to be updated by rewriting data stored in the platform's firmware storage device(s), such as flash components. A typical firmware update process involves writing new data to the flash component on a block-wise basis, wherein data are written to respective blocks one block at a time. Generally, some sort of roll-back mechanism is employed such that the original firmware (or at least a base portion of the original firmware) can be restored in the event of a failure during the update, such as a power glitch or system shutdown. However, once the new firmware has been successfully installed, the roll-back mechanism is no longer available.

Under today's firmware update techniques, limited security measure are available to ensure the new firmware is authentic. For example, many firmware upgrades are performed by first downloading a firmware image from a web site. Although such firmware will usually be downloaded from a legitimate vendor site, such as the platform manufacturer's or BIOS vendor's site, there are opportunities to download upgrades from other sites that are less trustworthy. Furthermore, web servers are known to be prone to attack, whereby an authentic firmware image may be replaced by a rogue firmware image without knowledge of a site's operator. The end result is that users may unknowingly download non-authentic firmware images, which may wreak havoc on the user's systems.

One technique for preventing the foregoing problem is to employ some form of authentication. For example, the update firmware image may require a digital signature or the like that can be verified against a certificate (accessible to the platform) containing a public key used to perform a signature check on the image. However, the certificate has no secure storage on today's platforms, leaving it vulnerable to possible attack or corruption.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1a-d are schematic diagrams of a platform configuration via which embodiments of the invention may be implemented, wherein FIG. 1a illustrates operations performed in connection with the flowchart of FIG. 2a, FIG. 1b illustrates operations performed in connection with the flowchart of FIG. 3a, FIG. 1c illustrates operations performed in connection with the flowchart of FIG. 2b, and FIG. 1d illustrates operations performed in connection with the flowchart of FIG. 3b.

FIG. 2a is a flowchart illustrating operations performed during a first phase of a two-phase secure firmware update process in accordance with one embodiment of the invention;

FIG. 3a is a flowchart illustrating operations performed during the second phase of the two-phase secure firmware update process in accordance with the embodiment of FIG. 2a;

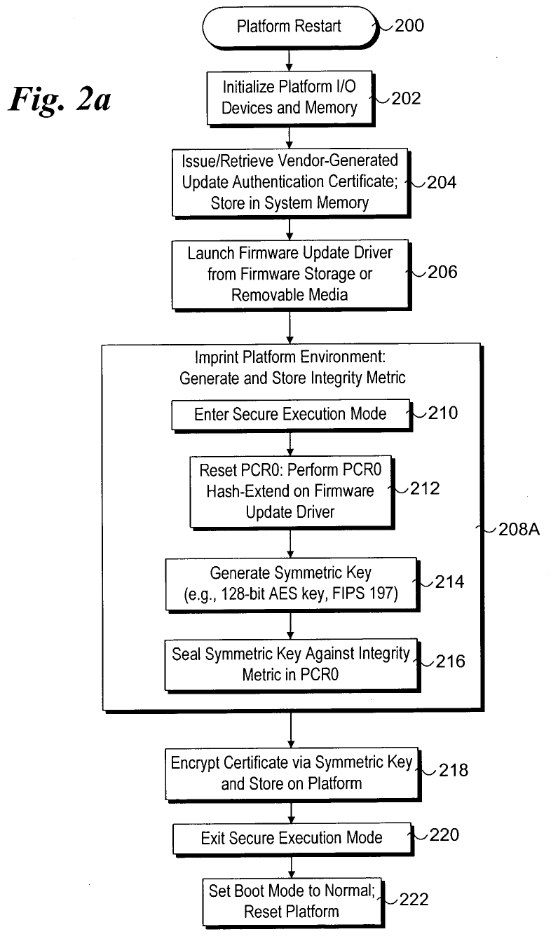

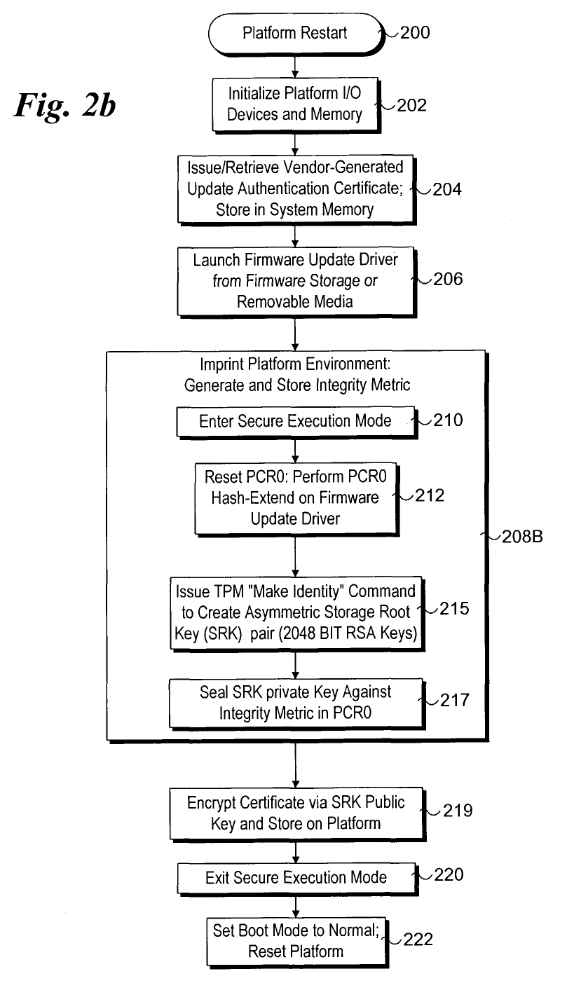

FIG. 2b is a flowchart illustrating operations performed during a first phase of a two-phase secure firmware update process in accordance with one embodiment of the invention; and

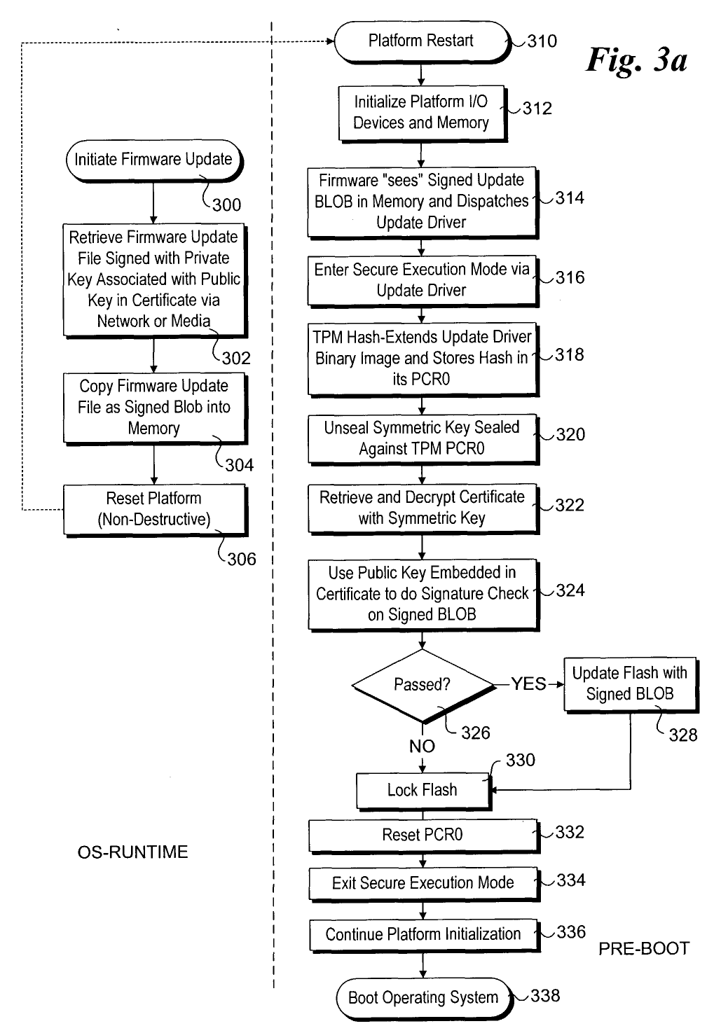

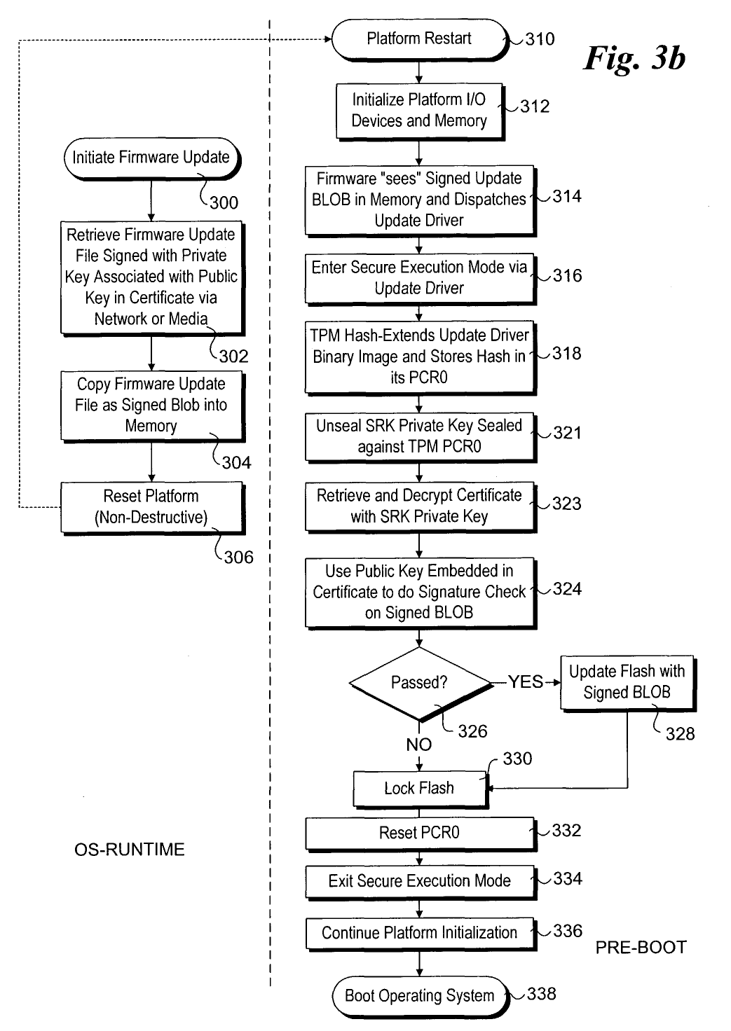

FIG. 3b is a flowchart illustrating operations performed during the second phase of the two-phase secure firmware update process in accordance with the embodiment of FIG. 2b.

### DETAILED DESCRIPTION OF PREFERRED EMBODIMENTS

Embodiments of a method to effect a trusted firmware/BIOS update in a pre-boot operational environment and systems for employing the method are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In accordance with aspects of the invention, trusted platform technology in combination with a secure authentication credential storage scheme are employed to effect a trusted firmware/BIOS update in the pre-boot. A firmware driver is launched from removable media or a platform firmware device, and is used to imprint the platform environment (i.e., seal update credentials) to the platform in a manufacturing environment in order to support successive trusted updates in the field (i.e., updates that use the “imprinted” environment to unseal the credentials as part of the update).

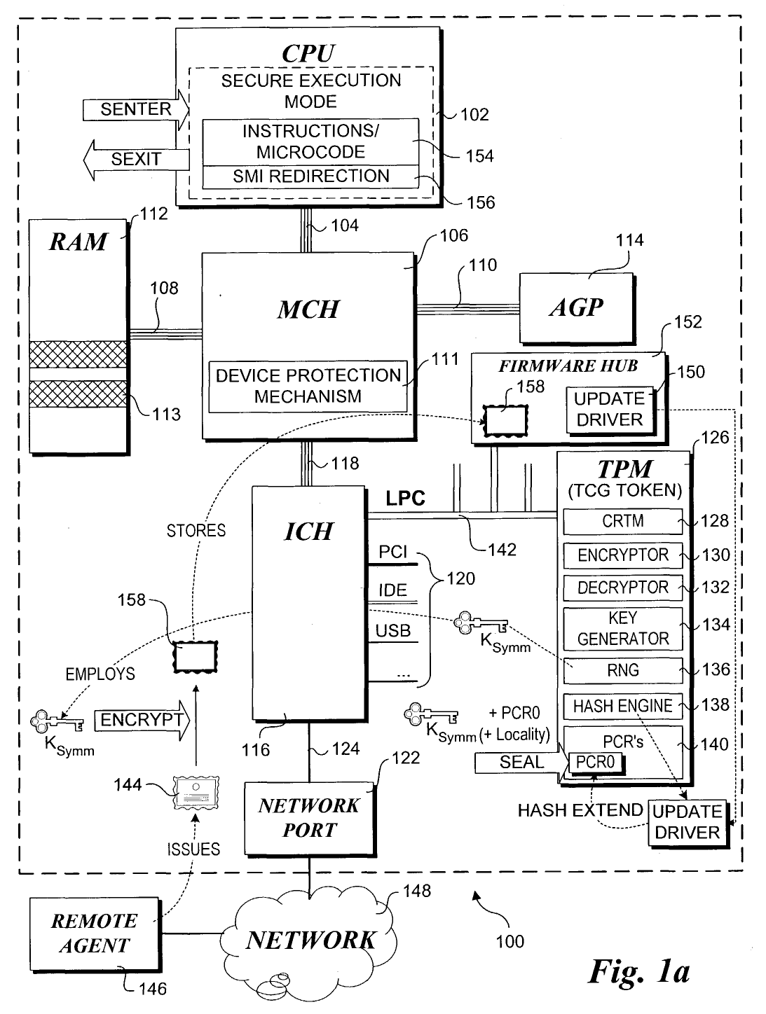

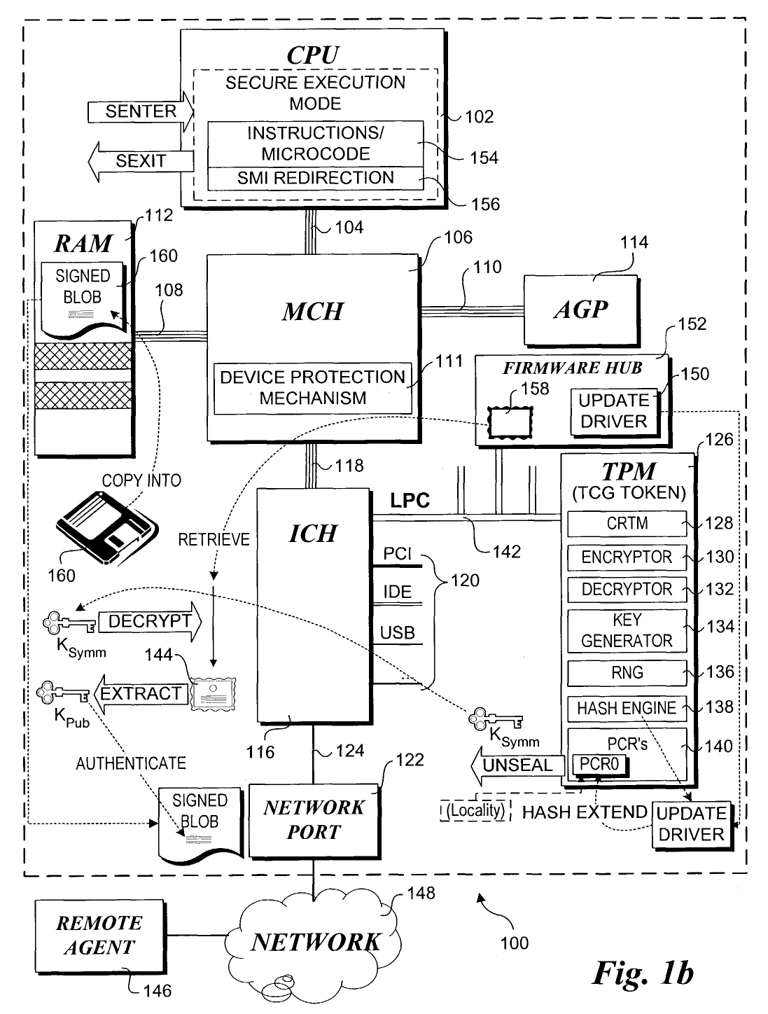

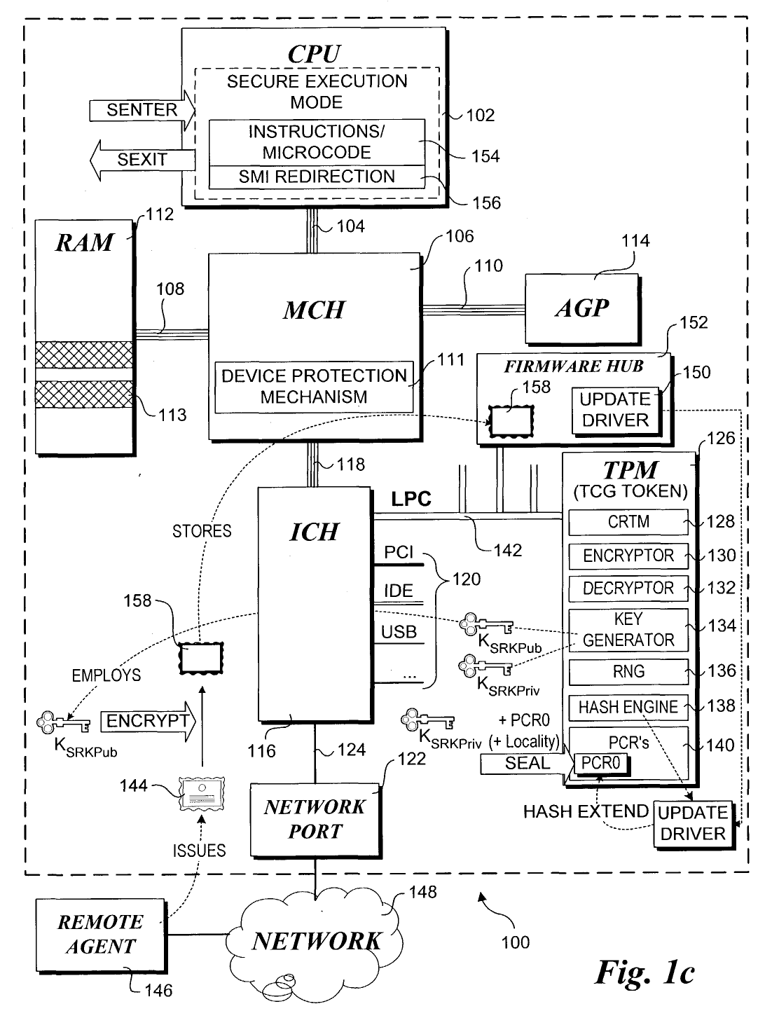

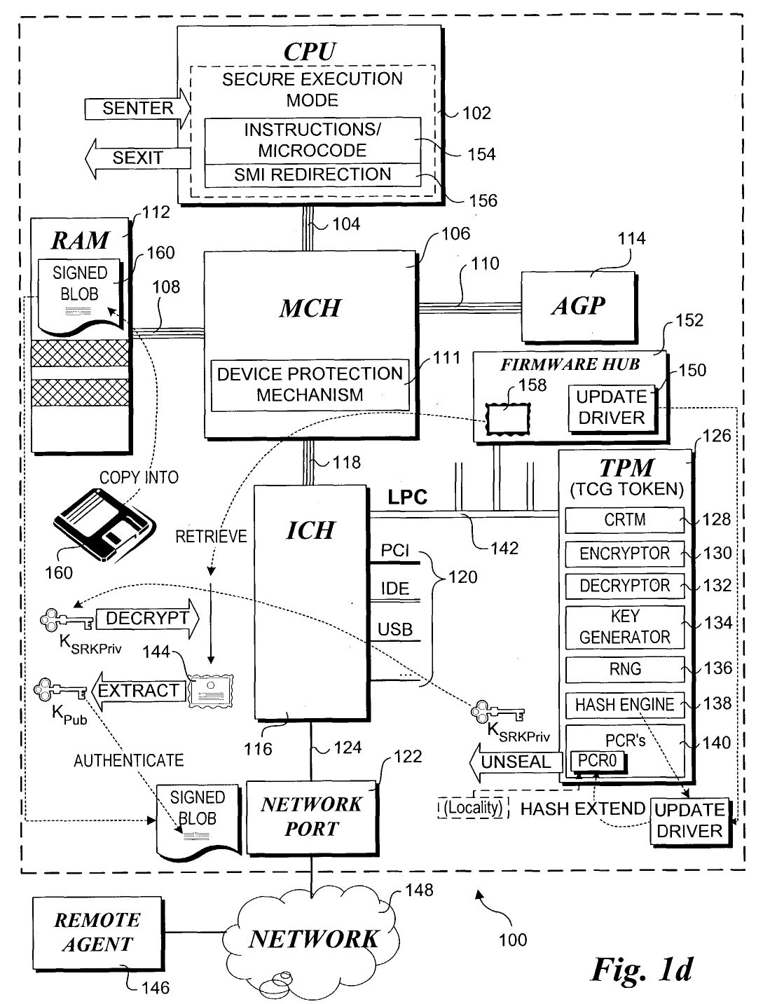

An exemplary computer architecture 100 suited for implementing embodiments of the invention described herein is shown in FIG. 1. The architecture includes a processor 102 coupled, via a bus 104, to a memory controller hub (MCH) 106, commonly referred to as the “Northbridge” under well-known Intel® chipset schemes. MCH 106 is coupled via respective buses 108 and 110 to system memory (i.e., RAM) 112 and an advanced graphics port (AGP) 114. MCH 106 provides memory control functions, and includes a device protection mechanism 111 that enables access to protected memory pages 113 in system memory 112. MCH 106 is further coupled to an Input/Output (I/O) controller hub (ICH) 116 via a bus 118. The ICH, which is commonly referred to as the “Southbridge,” provides a hardware interface to various I/O buses, ports and devices, depicted as items 120. These include a PCI bus, and IDE interface, a universal serial bus (USB), etc. ICH 116 is further coupled to a network port 122 via an I/O path 124.

In accordance with one aspect of the invention, a vendor-issued firmware update certificate is sealed via a secure storage mechanism that may only be accessed via a privileged secure execution mode of processor 102. In one embodiment, a Trusted Computing Group (TCG) (http://www.trustedcomputinggroup.org) security scheme is implemented to store and retrieve key and certificate data. In accordance with this embodiment, a TCG token comprising a trusted platform module (TPM) is employed. Generally, TPM functionality may be embodied as a hardware device (most common) or via software. For example, Integrated circuits have been recently introduced to support TPM functionality, such as National Semiconductor's LPC-based TCG-compliant security controller (Model number PC21100). Such an integrated circuit is depicted as a TPM 126 in FIG. 1.

TCG is an industry consortium concerned with platform and network security. The TCG main specification, Version 1.1 b, February, 2002 (http://www.trustedcomputinggroup.org), is a platform-independent industry specification that covers trust in computing platforms in general. TCG implements a trusted platform subsystem that employs cryptographic methods when establishing trust. The trusted platform may be embodied as a device or devices, or may be integrated into some existing platform component or components. The trusted platform enables an authentication agent to determine the state of a platform environment and seal data particular to that platform environment. Subsequently, authentication data (e.g., integrity metrics) stored in a TPM may be returned in response to an authentication challenge to authenticate the platform.

A “trusted measurement root” measures certain platform characteristics, logs the measurement data, and stores the final result in a TPM (which contains the root of trust for storing and reporting integrity metrics). When an integrity challenge is received, the trusted platform agent gathers the following information: the final results from the TPM, the log of the measurement data from the trusted platform measurement store, and TCG validation data that states the values that the measurements should produce in a platform that is working correctly. The operations of making an identity and enabling key-pair for the pre-boot environment enables TPM functionality to be employed for authentication purposes during and after pre-boot. Further details concerning the use of TPM 126 are discussed below.

TPM 126 provides several functions relating to security. These include an execution engine that is logically embodied as a Core Root of Trust Measurement (CRTM) 128; an encryptor 130, a decryptor 132, a key generator 134, a random number generator (RNG) 136, a hash engine 138, and Platform Configuration Registers (PCRs) 140.

Generally, a TPM by itself provides a baseline level of security for storing and accessing trust-related data and authentication measures. Under TPM Specification Design Philosophy, Specification Version 1.1, (Jun. 5, 2003), a TPM is to be an independent device that is not susceptible to tampering or incorrect usage. Accordingly, to further enhance this baseline security an embodiment of the invention implements a hidden access mechanism that enables access to TPM 126 via special bus cycles invoked on a low pin count (LPC) bus 142 per Intel LPC Interface Specification Revision 1.0, Sep. 29, 1997.

Flowcharts illustrating operations and logic performed in connection with a two-phase secure firmware update in accordance with one embodiment are respectively shown in FIGS. 2a and 3a. Typically, the first phase will be performed by a platform vendor or the like as part of a platform manufacturing process. The process starts with a platform restart in a start block 200. In response to the restart, platform I/O devices and system memory 112 are initialized in a block 202. For example, platform initialization operations, such as the power-on self-test (POST) operations are first performed, followed by memory configuration and the loading of firmware device drivers for accessing the memory and the platforms I/O devices.

Next, in a block 204 a vendor-generated update authentication certificate 144 is issued (or retrieved from a previously issued set of certificates) and stored in system memory 112. In one embodiment, this process may be performed via a remote agent 146 (such as a certificate server) that is linked in communication with platform 100 via a network 148.

In their simplest form, authentication certificates contain a public key and a name. As commonly used, a certificate also contains an expiration date, information identifying the certifying authority that issued the certificate (e.g., the platform vendor), a unique identifier (e.g., serial number), and perhaps other information. Most importantly, a certificate also contains a digital signature of the certificate issuer. The most widely accepted format for certificates is defined by ITU (International Telecommunications Union)-T X.509 international standard. Accordingly, in one embodiment authentication certificate comprises an ITU-T X.509 certificate.

In a block 206 a firmware update driver is launched, either from firmware storage or via removable media (e.g., CD-ROM or floppy disk). Optionally, the firmware device driver can be executed by remote agent 146. In one embodiment, a firmware update driver 150 is stored in a firmware storage device 152 comprising a firmware hub that is coupled to LPC bus 142.

In accordance with an aspect of the invention, the firmware update driver is used to “imprint” the platform “environment” on the platform during its manufacture such that the same platform environment must exist during a subsequent firmware update process to allow the process to proceed. This operation is depicted in a block 208A.

In accordance with one embodiment, the platform environment is imprinted by generating an integrity metric corresponding to the firmware update driver 150. In the illustrated embodiments of FIGS. 2a and 2b, this integrity metric is generated by performing a hash operation on the firmware update driver.

Imprinting the platform environment begins in a block 210, wherein processor 102 is caused to enter a secure execution mode (SEM). In one embodiment, execution of the firmware update driver 150 issues an “SENTER” instruction to processor 102. While in secure execution mode, all existing and potential future processor users are blocked from accessing the processor. Accordingly, the cases in which operating system run-time applications are running on processor 102, the current execution context of the operations are saved, SEM operations are performed, and the previously-saved context is restored. From a processor user perspective (e.g., the OS), SEM operations are transparent. SEM also temporarily blocks all interrupts (the interrupts are redirected for subsequent handling after exiting SEM), including system management interrupts (SMIs), as depicted by an SMI redirection block 156.

In accordance with one aspect of SEM, processor 102 contains special instructions and microcode 154 to access certain devices coupled to LPC 142 via special bus cycle timing. These devices include TPM 126. This provides one level of security between data stored in TPM 126 and attacks on platform 100.

A second level of security is provided by storing integrity metric data in platform configuration registers 140. PCR's 140 are employed for securely storing data in a manner where certain authentication information must be provided to TPM 126 in order to access a given PCR.

A PCR is a 160-bit storage location for discrete integrity measurements. All PCR registers are shielded-locations and are inside of the TPM. The decision of whether a PCR contains a standard measurement or if the PCR is available for general use is deferred to the platform specific specification.

A large number of integrity metrics may be measured in a platform, and a particular integrity metric may change with time and a new value may need to be stored. It is difficult to authenticate the source of measurement of integrity metrics, and as a result a new value of an integrity metric cannot be permitted to simply overwrite an existing value. (A rogue entity could erase an existing value that indicates subversion and replace it with a benign value.) Thus, if values of integrity metrics are individually stored, and updates of integrity metrics must be individually stored, it is difficult to place an upper bound on the size of memory that is required to store integrity metrics.

Because the PCR's of TCG1.1B can be accessed by any software agent, the introduction of trusted CPU's and the need to maintain backward compatibility has engendered the requirement for Locality within a TPM. Specifically, Locality 0 shall refer to untrusted agents who can access the TPM in the fashion described in today's TPM specification. In the future, the TPM will support higher localities. Locality 4, for example, shall be signaled by the CPU when it enters the SEM; the platform shall indicate the entrance to SEM to the TPM. Certain operations against certain PCR's shall only be possible at locality 4. This partitioning will allow for access control to given PCR operations, such as Seal, only while in SEM. It is this marriage of SEM and Seal that adds additional security to the flash update protocol described in this art.

The PCR is designed to hold an unlimited number of measurements in the register. It does this by using a cryptographic hash and hashing all updates to a PCR. The pseudo code for this is:
PCRᵢNew=HASH (PCRᵢ Old value ∥ value to add)
   Updates to a PCR register are sometimes referred to as “extending” the PCR, while the data measured to the PCR is sometimes called the “extend”

In one embodiment, PCR0 provides capability of being reset. Accordingly, a hash-extend operations may be performed in a manner that produces PCR0 values that are independent of previously stored register values. This is advantageous with respect to being able to store integrity metrics corresponding to a given platform environment, and then subsequently compare integrity metrics corresponding to a current platform environment with the given platform environment.

For example, in a block 212 PCR0 is reset, and a hash-extend is performed on firmware update driver 150 using hash engine 138, with the result being stored in PCR0. In this context, the hash-extend operates on a reset register value (i.e., 0), and so the hash-extend simply reflects a hash of firmware update driver 150. Thus, once loaded, firmware update driver 150 corresponds to one of the platform firmware environment components, the hash of the driver comprises an integrity metric corresponding to the platform environment. (It is noted that an integrity metric corresponding to a platform environment may reflect a single environment component (i.e., firmware/software component), or a combination of components used to form an environment that exists at the time the integrity metric is measured.)

Continuing with the operations in block 208A, the next operation is performed in a block 214, wherein a symmetric key (K_{Symm}) is generated using key generator 134 and/or random number generator 136. In one embodiment, K_{symm} comprises a 128-bit AES (advanced encryption standard) key compliant with the Federal Information Processing Standard (FIPS) 197 standard.

The next operation is to “seal” authentication credentials such that they may not be accessed by outside agencies. In one embodiment, this is performed in a block 216 by sealing K_{Symm} against the integrity metric stored in PCR0. In essence, what this does is require the same integrity metric to exist in PCR0 before the sealed value (K_{Symm}) may be unsealed, as described below.

The root of trust reporting (RTR) must have a cryptographic identity in order to distinguish configuration reports and a challenger must be able to authenticate the platform identity. The platform identity is an embodiment of all the roots of trust. A conventional identity ordinarily is a label that is unique within the context of an application domain. In contrast, a cryptographic identity is universally unique and non-guessable. To create such a cryptographic identity it must be infeasible to guess an identity given a feedback loop for checking. Additionally, proof of possession of a cryptographic identity should be possible without disclosing it.

Platform uniqueness is achieved through an asymmetric key pair, known as the endorsement key (EK). It is embedded in the TPM. Use of the EK is restricted such that the only external representation of the platform is through aliases, known as attestation identities. Prior to TPM use, a platform identity must be created. The EK may be installed during platform manufacture or generated by a vendor just before a customer takes delivery. TPM and platform manufacturers and their distributors determine the exact point in time when the EK is created. TPM and platform manufacturers are involved in EK creation because they vouch for the validity of the EK and TPM containing the EK.

Another important platform identifier key is the Storage Root Key (SRK). A TMP stores keys using a hierarchical structure, with the SRK at the top. The SRK is an RSA 2048-bit key that is generated automatically when a platform owner is established. It is assumed that both the EK and the SRK are created prior to performing the process of FIGS. 2A and 2B.

Sealing is effectuated via the TPM_Seal command. The SEAL operation allows software to explicitly state a future “trusted” configuration that the platform must be in for the secret (stored via the TPM_Seal command) to be revealed. The SEAL operation also implicitly includes the relevant platform configuration (PCR-values) when the SEAL operation was performed. The SEAL operation uses the tmpProof value to BIND a BLOB (Binary Large Object) to an individual TPM. To retrieve the secret, and UNSEAL operation is performed. If the UNSEAL operation succeeds, proof of the platform configuration that was in effect when the SEAL operation was performed is returned to the caller, as well as the secret data. In one embodiment, a PCR provides a means for storing indicia identifying a processor locality at the time the secret is sealed; thus, the same locality is required to unseal the secret.

In response to the TPM_Seal command, external data is concatenated with a value of integrity metric sequence and encrypted under a parent key. The TPM_Unseal command may be subsequently used to decrypt the BLOB using the parent key and export the plaintext data if the current integrity metric sequence inside the TPM matches the value of integrity metric sequence inside the BLOB. The integrity metric in the current example is the value in PCR0. In one embodiment, indicia identifying the processor locality (e.g., locality 4 while in SEM), is stored in the PCR0 as well.

The next operation shown is depicted by a block 218, wherein authentication certificate 144 is encrypted via K_{Symm} and stored as an encrypted certificate 158 in a storage device that is accessible to platform 100. For example, the encrypted certificate could be stored in firmware device 150 (e.g., via a portion of the firmware device reserved for storing variable data (a.k.a., non-volatile RAM). The encrypted certificate may also be stored elsewhere, such as in the host-protected area of a disk drive (not shown) coupled to ICH 116 via the IDE bus.

The first phase of the two-phase update process is completed in blocks 220 and 222 by exiting the secure execution mode (using the SEXIT instruction), setting the boot mode to normal, and then resetting the platform.

Operations and logic corresponding to the second phase of the two-phase process in accordance with the embodiment of FIG. 2a is shown in the flowchart of FIG. 3a. A first set of operations shown on the left hand side of the flowchart will typically be performed during operating system runtime, although this is not meant to be limiting. These operations comprise firmware update setup operations that are performed prior to pre-boot operations shown on the right-hand side of the flowchart.

The setup operations begin in a block 300 in which a firmware update process is initiated. For instance, a typical firmware update process will be initiated by navigating to a web site via which firmware update images may be downloaded, such as a site operated or authorized by the vendor of a given platform. The user will choose an image to download based on platform identification information or the like (e.g., a serial or model number), and a file will be returned to the platform. In many instances, the file will comprise an executable containing a firmware update program along with the update image. These operations are depicted in a block 302. In another embodiment, the firmware update image (or update file) may be loaded directly from removable media 159, as depicted in FIG. 1b.

Upon receipt of the file, the executable is launched to cause the firmware update image to be copied into system memory 112, as shown by a block 304. Other mechanisms may also be used to copy the firmware update image into the system memory. In one embodiment, the firmware update image is signed with a private key associated with the public key contained in authentication certificate 144. Thus, the private key comprises a second authentication credential that is employed in authenticating the firmware update image as described below. Accordingly, the firmware update image is stored in system memory 112 as a signed BLOB. The platform is then reset in a block 306. In one embodiment, a non-destructive reset is used, such as via issuing an INIT or S3 command to an Intel® IA-32 processor. The non-destructive reset allows data stored in memory and various registers to persist across the reset and also unlocks the flash part so that the ensuing flash update operation can update the firmware store.

The firmware update image authentication and subsequent firmware update process are performed in response to a platform restart shown in a start block 310. As before, platform memory and I/O devices are initialized in a block 312. In a block 314, a firmware configuration component recognizes (i.e., “sees” that there is a signed update BLOB in system memory 112 and dispatches update driver 150 for execution.

Upon execution, the firmware update drive issues the SENTER command to cause processor 102 to enter its secure execution mode in a block 316. Processor 102 then hash-extends the binary image of update driver 150 and stores the result in PCR0. For both this hash, and the previous hash, the same hash algorithm is employed, such as the SHA-1 hash algorithm.

The net result is that the same hash value is now present in PCR0 that was present in this register when K_{Symm} was sealed. Thus, K_{Symm} can now be unsealed via a TPM_Unseal command that references the integrity metric contained in PCR0, as depicted by a block 320. If the locality indicia was previously stored above, the processor will also have to be in the same locality (e.g., locality 4) as when K_{Symm} was sealed to access the key. The encrypted authentication certificate 158 is then retrieved and decrypted in a block 322. Once decrypted, the public key (K_{pub}) embedded in the certificate may be extracted and used to perform a signature check on signed BLOB 160.

If the signature check passes, as determined in a decision block 326, existing firmware (e.g., stored on firmware device 152) is updated using the signed BLOB (i.e., updated firmware image). For example, suppose that firmware device 152 comprises a flash device. In this instance, the firmware update is performed in accordance with well-known firmware update techniques for flash devices, such as performing a block-wise copy process with rollback. The flash part is then locked in a block 330 to prevent further access to the firmware. Subsequently, PCR0 is reset in a block 332, processor 102 exits the secure execution mode in a block 334, and platform pre-boot initialization operations are continued in a block 336. The operating system is then booted in the normal manner in a block 338.

If the authentication (signature check) of the firmware update image fails, as determined in decision block 326, the logic bypasses the operation of block 328, thus prevented the existing firmware to be updated. Accordingly, any firmware image that isn't signed with the proper private key will be prevented from being loaded onto platform 100.

In accordance with another embodiment illustrated in FIGS. 1c-d, 2b, and 3b, an asymmetric key pair is employed rather than a symmetric key. At the same time, like operations in the flowcharts of FIG. 2a-b and 3a-b share the same block reference numbers; accordingly, specific details of the operations performed by these blocks are not repeated, but rather only the differences between the processes are discussed below.

The process begins in a block 200 with a platform restart, and performs operations in blocks 202, 204, and 206 in the same manner as discussed above. In a block 208B, the platform environment is imprinted in a similar manner to block 208A. However, in this instance, a private key of an asymmetric key pair is sealed against the SRK. More particularly, in a block 215 a TPM “Make_identity” command is issued. This command is used to generate an identity in a TPM and to request attestation to that identity. Issuance of the TPM_MakeIdentity command produced a public key (K_{SRKPub}) and a private key (K_{SRKPriv}). The public key of the new TPM identity is called identityPubKey. The private key of the new TPM identity is called tpm_signature_key.

In a block 217 the private key (K_{SRKPriv}) is sealed against PRC0 by referencing the integrity metric derived from the hash-extend of firmware update driver 150 in block 212 in a manner similar to that discussed above with reference to block 216. In addition, authentication certificate 144 is encrypted using K_{SRKPriv} in a block 219 and stored on the platform. The operations of blocks 220 and 222 are then performed to complete the first phase of the update process.

Moving to the flowchart of FIG. 3b, the operations performed in blocks 300, 302, 304, 306, 310, 312, 314, 316, and 318 are performed in a manner similar to that discussed above for like-numbered blocks. In a block 321, and TPM_Unseal command is issued referencing PCR0 to unseal the SRK private key (K_{SRKPriv}). Encrypted authentication certificate 158 is then retrieved and decrypted using K_{SRKPriv} in a block 323. The rest of the operations in blocks 324, 326, 328, 330, 332, 334, 336, and 338 are performed in a manner similar to that discussed above for like-numbered blocks to complete the update process.

As discussed above, the various operations performed during the two-phase firmware update process are enabled via execution of instructions contained in a firmware update driver (e.g., firmware update driver 150). Thus, embodiments of this invention may be used as or to support a software/firmware program or module executed upon some form of processing core (such as the CPU of a computer) or otherwise implemented or realized upon or within a machine-readable medium. A machine-readable medium includes any mechanism for storing or transmitting information in a form readable by a machine (e.g., a computer). For example, a machine-readable medium can include such as a read only memory (ROM); a random access memory (RAM); a magnetic disk storage media; an optical storage media; and a flash memory device, etc. In addition, a machine-readable medium can include propagated signals such as electrical, optical, acoustical or other form of propagated signals (e.g., carrier waves, infrared signals, digital signals, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1. A method comprising:
securely storing a first authentication credential on a platform;
receiving a firmware update image containing a second authentication credential;
authenticating the firmware update image via the first and second authentication credentials; and
updating existing firmware with the firmware update image if the firmware update image is authenticated.

2. The method of claim 1, further comprising:
imprinting platform configuration data on the platform during a manufacturing process; and
preventing the first authentication credential from being accessed unless a configuration of the platform corresponds to a configuration identified by the platform configuration data.

3. The method of claim 2, wherein the platform configuration data are derived from a firmware update driver that is employed to update the existing firmware with the firmware update image.

4. The method of claim 1, wherein the first authentication credential comprises an authentication certificate.

5. The method of claim 4, wherein the authentication certificate is securely stored by performing operations including:
generating an asymmetric key pair including a public key and a private key;
encrypting the authentication certificate with the public key; and
securely storing the private key.

6. The method of claim 4, wherein the authentication certificate is securely stored by performing operations including:
generating a key;
encrypting the authentication certificate with a key; and
securely storing the key.

7. The method of claim 6, wherein the key is securely stored by performing operations including:
determining a first platform configuration;
storing data relating to the platform configuration;
sealing the key in a storage device; and
preventing access to the key unless a current platform configuration matches the first platform configuration.

8. The method of claim 7, wherein the platform configuration is based on a configuration of a firmware update component.

9. The method of claim 6, wherein the key is stored on a trusted platform module.

10. The method of claim 1, wherein the operation of securing storing the first authentication credential on the platform is performed by a manufacturer of the platform.

11. The method of claim 1, wherein the operations of authenticating the firmware update image via the first and second authentication credentials and updating the existing firmware with the firmware update date image are performed during a pre-boot phase of the platform.

12. The method of claim 1, further comprising retrieving the first authentication credential via a secure execution mode of a platform processor.

13. The method of claim 1, wherein the platform includes a processor that may operate in different locality modes, and wherein the first authentication credential may only be retrieved while operating the processor in a specific locality mode.

14. A method for performing a secure firmware update, comprising:
securely storing a first authentication credential on a platform, the first authentication credential containing a first digital signature identifying a manufacturer of the platform;
receiving a firmware update image containing a second authentication credential comprising a second digital signature;
extracting the first and second digital signatures;
comparing the first and second digital signatures; and
updating existing firmware with the firmware update image if the first and second digital signatures match.

15. The method of claim 14, wherein the first authentication credential comprises an authentication certificate including a public key owned by the manufacturer and the firmware update image is signed using a private key owned by the manufacturer corresponding to the public key.

16. The method of claim 15, wherein the first authentication credential is securely stored by performing operations including:
generating one of a symmetric key and an asymmetric key pair including first and second asymmetric keys;
encrypting the first authentication credential with one of the symmetric key and the first asymmetric key;
storing the first authentication credential in encrypted form on a storage device to which the platform may access; and
storing one of the symmetric key and the second asymmetric key on a secure storage device.

17. The method of claim 16, wherein the secure storage device comprises a trusted platform module.

18. The method of claim 17, further comprising switching an operating mode of a processor for the platform to a secure execution mode to access the secure storage device, wherein the secure storage device may only be accessed by the processor when it is in the secure execution mode.

19. A machine-readable media having instructions stored thereon that when executed on a platform perform operations, including:
extracting a first authentication credential stored on the platform identifying a manufacturer of the platform;
extracting a second authentication credential corresponding to a firmware update image stored on the platform;
authenticating the firmware update image via the first and second authentication credentials; and
updating existing firmware with the firmware update image if the firmware update image is authenticated.

20. The machine-readable media of claim 19, wherein the instructions comprise firmware.

21. The machine-readable media of claim 19, wherein the operations are performed during a pre-boot phase for the platform.

22. The machine-readable media of claim 19, wherein the machine-readable media comprises a firmware storage device.

23. The machine-readable media of claim 19, wherein executions of the instructions further performs the operation of imprinting platform configuration data to the platform.

24. The machine-readable media of claim 19, wherein the platform configuration data pertains to a firmware update driver employed to update the existing firmware with the firmware update image.

25. A system comprising:
a processor;
a secure token, operatively coupled to the processor;
a firmware storage device, operatively couple to the processor, in which a plurality of firmware instructions are stored, which when executed by the processor perform operations including:
extracting a first authentication credential stored on the system identifying a manufacturer of the system;
extracting a second authentication credential corresponding to a firmware update image stored on the platform;
authenticating the firmware update image via the first and second authentication credentials; and
updating existing firmware with the firmware update image if the firmware update image is authenticated.

26. The system of claim 25, wherein the secure token comprises a trusted platform module (TPM).

27. The system of claim 25, wherein the method operations are performed by the processor when the processor is operating in a secure execution mode.

28. The system of claim 27, wherein the secure token is operatively coupled to the processor such that the secure token may only be accessed by the processor when the processor is operating in the secure execution mode.

29. The system of claim 25, further comprising:
a memory controller hub, coupled to the processor via a first bus;
a input/output controller hub (ICH), coupled to the memory controller hub via a second bus; and
a third bus, coupled between the ICH and the TPM.

30. The system of claim 28, wherein the firmware storage device is coupled to the ICH via the third bus.
